(19) United States
(12) Patent Application Publication
(10) Pub. No.: US 2019/0091697 A1
(43) Pub. Date: Mar. 28, 2019

(54) STRUCTURE OF LOTTERY TICKET DESTRUCTION APPARATUS

(71) Applicant: SAINT-FUN INTERNATIONAL LTD., New Taipei City (TW)

(72) Inventor: Shih-Wei Ho, New Taipei City (TW)

(21) Appl. No.: 15/713,719

(22) Filed: Sep. 25, 2017

(51) Int. Cl. B02C 18/22; B02C 18/00

(52) U.S. Cl. CPC B02C 18/2216; B02C 2018/0038; B02C 18/0007; B02C 18/2283

(57) ABSTRACT

A lottery ticket destruction apparatus includes a housing holding a motor with a pinion, sensors for detecting insertion of lottery tickets and starting up the motor, a first set of sheet-transfer rollers for flattening inserted lottery tickets and delivering flattened lottery ticket through the sensors, a set of scissor action rotary cutters with spiral cutting edges for cutting lottery tickets into small pieces through a scissor action, a second set of sheet-transfer rollers for delivering flattened lottery tickets from the sensors to the set of scissor action rotary cutters for cutting, and a transmission gear set drivable by the pinion to rotate the first and second sets of sheet-transfer rollers and the set of scissor action rotary cutters at different speeds, and shield plates surrounding the scissor action rotary cutters to shield cutting dust.

### BACKGROUND OF THE INVENTION

### (a) Field of the Invention

The present invention relates to an apparatus for destructing lottery tickets, and more particularly to an improved structure of lottery ticket destruction apparatus, which simulates a scissor action to cut off lottery tickets into small pieces rapidly and efficiently.

### (b) Description of the Prior Art

Many lottery ticket destruction apparatuses are known. For example, Taiwan Utility Numbers 84208584, 85204451, and 85203923 disclose lottery ticket cutting and destruction techniques. These designs teach the operation of scissor action rotary cutters for cutting a series of lottery tickets into three narrow elongated strips. These prior art designs cannot cut every single lottery ticket into small pieces. The three narrow elongated strips will curl up and get tangled together, taking up much waste storage space in the waste basket. Thus, the user needs to frequently clean the waste basket, thus not only complicating the lottery destruction work but also significantly lowering the lottery destruction efficiency.

U.S. Patent Publication No. 20150129691, equivalent to Taiwan Utility M472268 and China Patent CN 203621078U, discloses a lottery ticket destruction apparatus that includes a housing of flip-turn design convenient to open for maintenance, a motor mounted in the housing, a transmission gear set mounted on the outside of the housing and coupled to the motor, a set of sheet-transfer rollers rotatable by the transmission gear set at a low speed to flatten inserted lottery tickets, a set of scissor action rotary cutters disposed below the set of sheet-transfer rollers and rotatable by the transmission gear set at a middle speed to cut an inserted series of lottery tickets into three narrow elongated pieces, and a set of pull-and-push rollers disposed below the set of scissor action rotary cutters and rotatable by the transmission gear set at a high speed to stretch the cut pieces of the series of lottery tickets into fragments.

According to the aforesaid design of lottery ticket destruction apparatus of U.S. Patent Publication No. 20150129691, the set of pull-and-push rollers rotatable at a high speed in stretching the three narrow elongated strips of the series of lottery tickets into fragments by separating the cut pieces of one lottery ticket from those of other lottery tickets. Thus, the transmission gear set bears a large load and the gears will wear quickly. An improvement in this regard is necessary.

Further, in the aforesaid prior art design of lottery ticket destruction apparatus, the set of scissor action rotary cutters is disposed below the set of sheet-transfer rollers and rotatable by the transmission gear set at a middle speed to cut inserted lottery tickets into three narrow elongated pieces and the set of pull-and-push rollers is disposed below the set of scissor action rotary cutters and rotatable by the transmission gear set at a high speed to stretch the cut pieces of the series of lottery tickets into fragments. The overall structure of the lottery ticket destruction apparatus is complicated, and after repeated lottery ticket destruction work, it cannot ensure that each lottery ticket can be destroyed into pieces, so the yield does not meet the expectation.

Further, when stretching the cut narrow elongated pieces, paper dust can occur and the sensors can be covered by the produced paper dust, affecting the counting function.

### SUMMARY OF THE INVENTION

The present invention has been accomplished under the circumstances in view. It is the main object of the present invention to provide an improved structure of lottery ticket destruction apparatus, which comprises a housing, a transmission gear set, a first set of sheet-transfer rollers, a second set of sheet-transfer rollers, and a set of scissor action rotary cutters. The first and second sets of sheet-transfer rollers are rotated by the transmission gear set at the same speed. The first set of sheet-transfer rollers is adapted for flattening inserted lottery tickets and delivering flattened lottery tickets through the sensors. The sensors are adapted for starting up the motor and counting the number of lottery tickets passing therethrough. The second set of sheet-transfer rollers is adapted for delivering flattened lottery tickets from the sensors to the set of scissor action rotary cutters. The scissor action rotary cutters are configured to provide a plurality of cutting grooves spaced around the periphery thereof for cutting lottery tickets into small pieces through a scissor action without generating any stretching force. Thus, the invention ensures that the components of the lottery ticket destruction apparatus can run smoothly, extending the service life. Further, the whole structure of the lottery ticket destruction apparatus is more compact and streamlined.

Preferably, the cutting grooves of each scissor action rotary cutter are spirally extended around the periphery of the respective scissor action rotary cutter. Each scissor action rotary cutter further comprises a spiral cutting edge abutted at one lateral side of each spiral cutting groove thereof. Thus, when the scissor action rotary cutters are rotated, the inserted lottery tickets are cut into small pieces by the multiple spiral cutting edges like the cutting of multiple pairs of scissors.

Preferably, the lottery ticket destruction apparatus further comprises a shield plate surrounding each scissor action rotary cutter to isolate the respective scissor action rotary cutter from the internal space of the housing. The shield plates isolate the scissor action rotary cutters from the internal space of the housing, preventing flying cutting dust from contaminating the sensors or to affect normal counting function of the sensors during rotation of the scissor action rotary cutters to cut off inserted lottery tickets into small pieces.

Preferably, each shield plate extends upwards and has an opening for the passing of the second set of sheet-transfer rollers partially.

Since the set of scissor action rotary cutters simulates the cutting action of pairs of scissors to cut inserted lottery tickets into small pieces, the lottery ticket destruction apparatus saves waste lottery ticket storage space and facilitates further follow-up procedure.

### BRIEF DESCRIPTION OF THE DRAWINGS

FIG. 1 is an oblique top elevational view of a lottery ticket destruction apparatus in accordance with the present invention.

FIG. 2 corresponds to FIG. 1, illustrating the top cover shell of the housing opened from the bottom body shell.

FIG. 3 illustrates the internal arrangement of the lottery ticket destruction apparatus in accordance with the present invention.

FIG. 4 is an exploded view of a part of the lottery ticket destruction apparatus in accordance with the present invention.

FIG. 5 is a sectional side view of the lottery ticket destruction apparatus in accordance with the present invention.

FIG. 6 is another exploded view of the lottery ticket destruction apparatus in accordance with the present invention.

FIG. 7 is a schematic drawing illustrating an operation status of the transmission gear set of the lottery ticket destruction apparatus in accordance with the present invention.

FIG. 8 illustrates the positioning relationship between the shield plates, the sets of sheet-transfer rollers and the set of scissor action rotary cutters.

FIG. 9 is a schematic drawing illustrating a series of lottery tickets delivered through the two sets of sheet-transfer rollers and the set of scissor action rotary cutters.

FIG. 10 corresponds to FIG. 9, illustrating lottery tickets passing through the set of scissor action rotary cutters to be cut into small pieces.

### DETAILED DESCRIPTION OF THE PREFERRED EMBODIMENTS

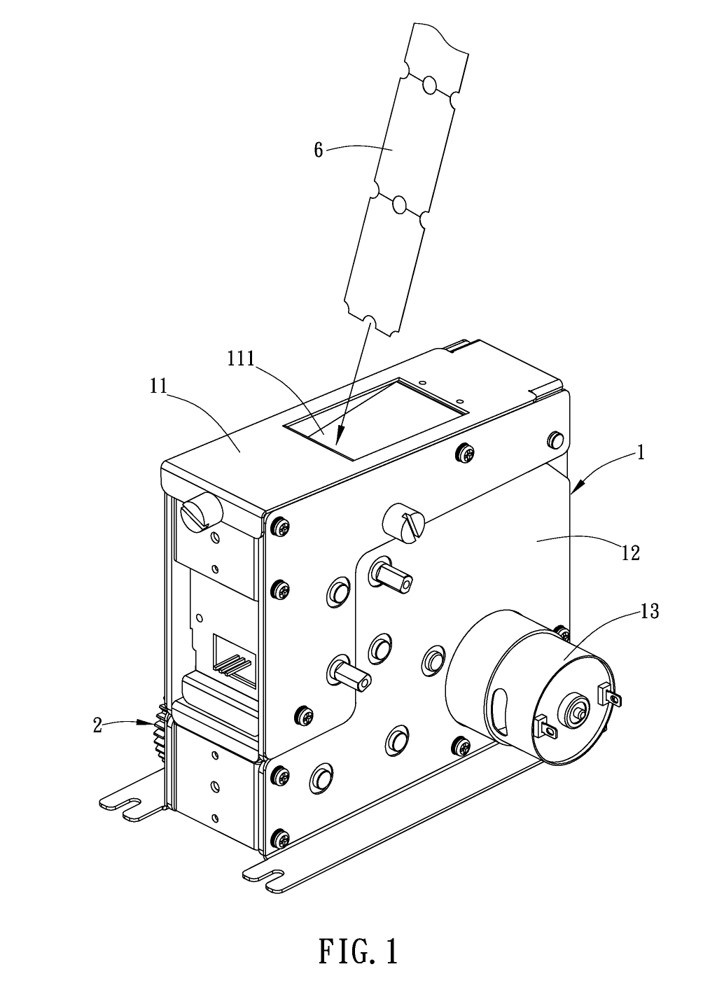

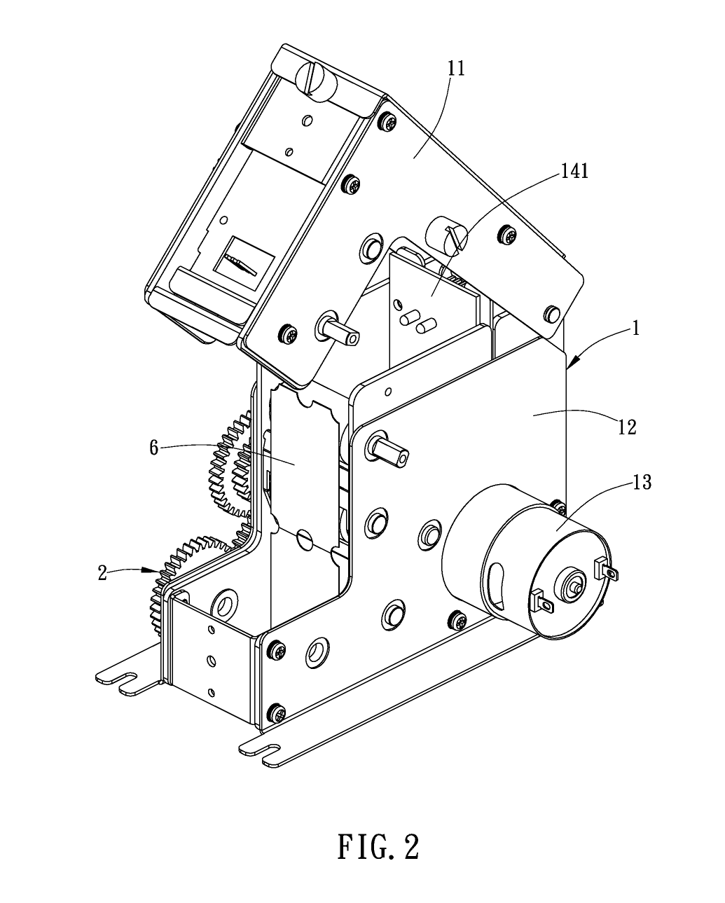

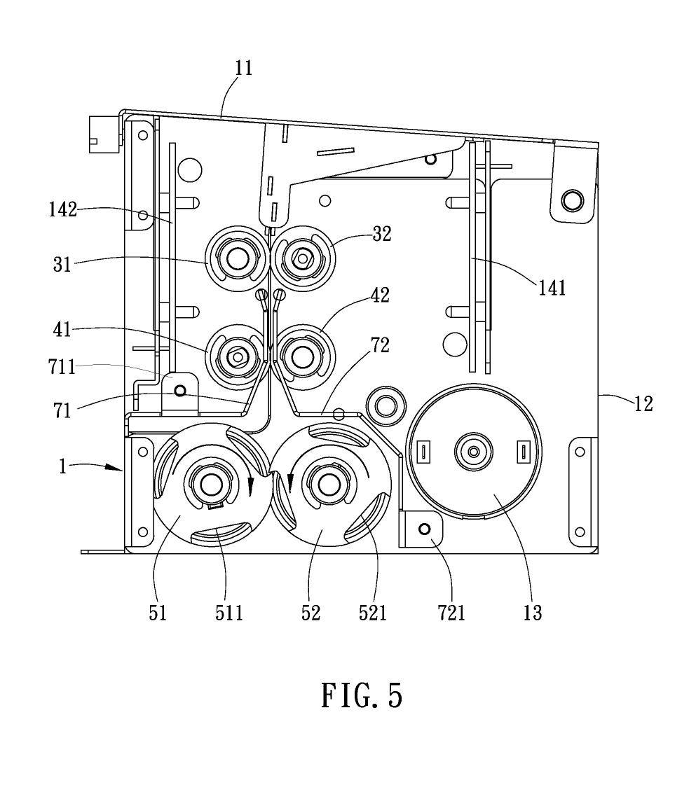

Referring to FIGS. 1-6, a lottery ticket destruction apparatus in accordance with the present invention is shown. The lottery ticket destruction apparatus comprises a housing 1, a transmission gear set 2, two sets of sheet-transfer rollers 31,32;41,42, and a set of scissor action rotary cutters 51,52. The set of scissor action rotary cutters 51,52 simulates the action of a pair of scissors to cut lottery tickets 6 into pieces.

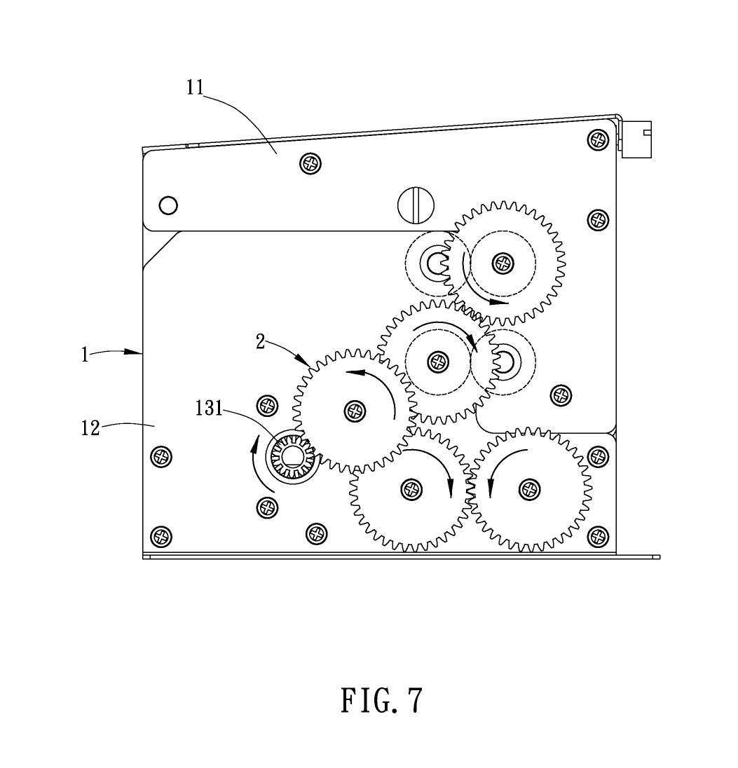

The housing 1 is of a flip-turn design. As shown in FIG. 1, the housing 1 comprises a top cover shell 11 and a bottom body shell 12. The top cover shell 11 and the bottom body shell 12 are pivotally coupled together such that the top cover shell 11 can be turned relative to the bottom body shell 12 and opened or closed. The top cover shell 11 comprises a top opening 111, and guide plate for guiding lottery tickets 6 inserted into the top opening 111 toward the inside of the bottom body shell 12 for the lottery tickets 6 into the inside of the housing 1. The bottom body shell 12 has mounted therein a motor 13 for driving a pinion 131 (see FIG. 7). Further, sensors 141;142 are respectively mounted in the top cover shell 11 and the bottom body shell 12.

The transmission gear set 2, as shown in FIG. 7, consists of a plurality of gears respectively mounted on the outer wall of the bottom body shell 12 and meshed with one another.

The pinion 131 drives the two sets of sheet-transfer rollers 31,32;41,42 and the set of scissor action rotary cutters 51,52 to rotate, wherein the sets of sheet-transfer rollers 31,32;41,42 are rotated at the same speed; the set of scissor action rotary cutters 51,52 is rotated at a relatively higher speed.

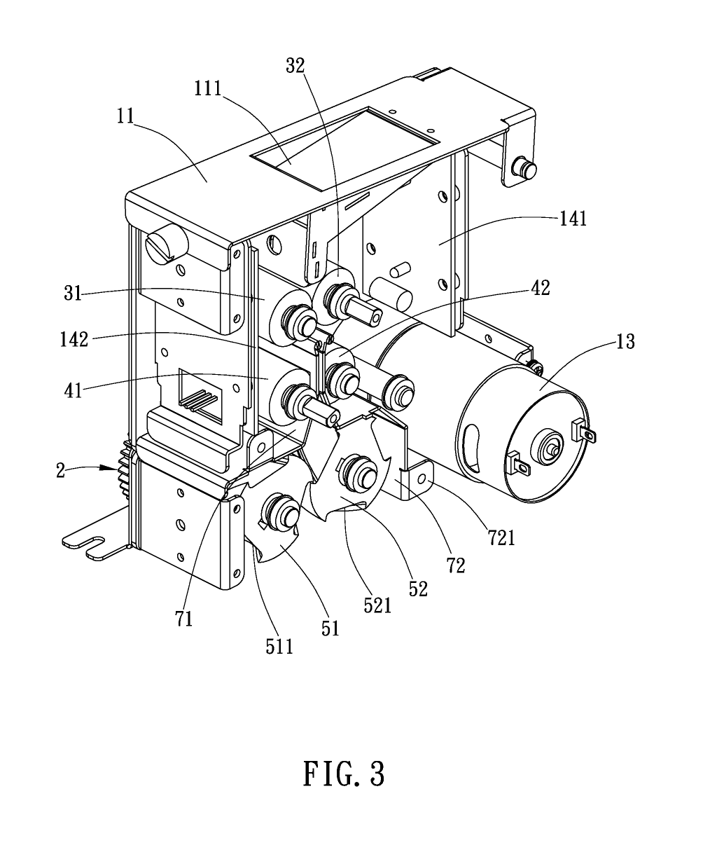

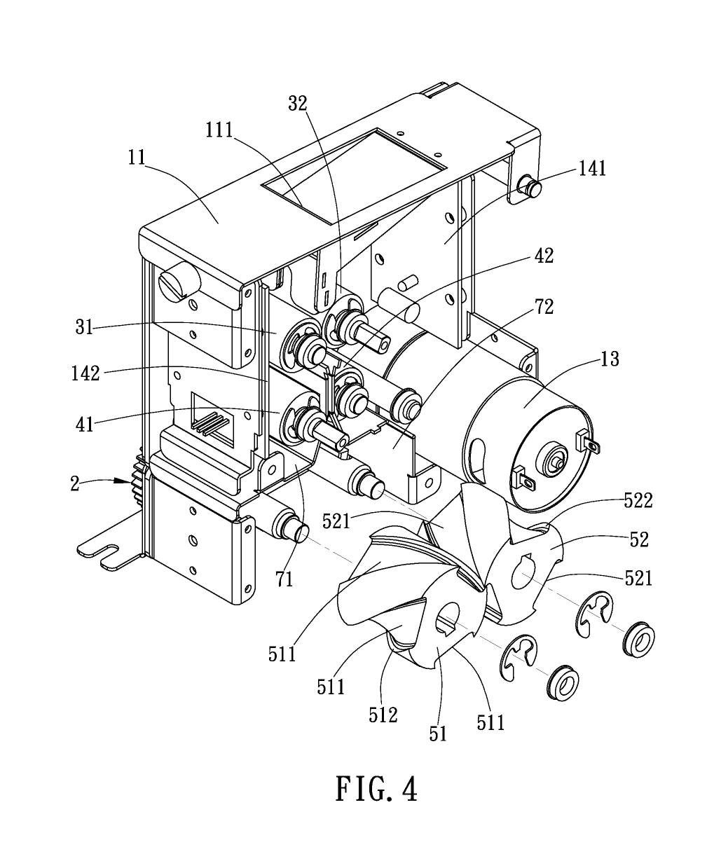

Referring to FIGS. 3 and 4, the two sets of sheet-transfer rollers 31,32;41,42, namely a first set of sheet-transfer rollers 31,32 and a second set of sheet-transfer rollers 41,42 arranged at different elevations and disposed below the top opening 111 of the top cover shell 11. Further, the first set of sheet-transfer rollers 31;32 is adapted to flatten lottery tickets 6 and to deliver the flattened lottery tickets 6 through the sensors 141,142 to start up the motor and to count the number of lottery tickets 6 passing there through. The second set of sheet-transfer rollers 41,42 continuously deliver the flattened lottery tickets 6 toward the set of scissor action rotary cutters 51,52.

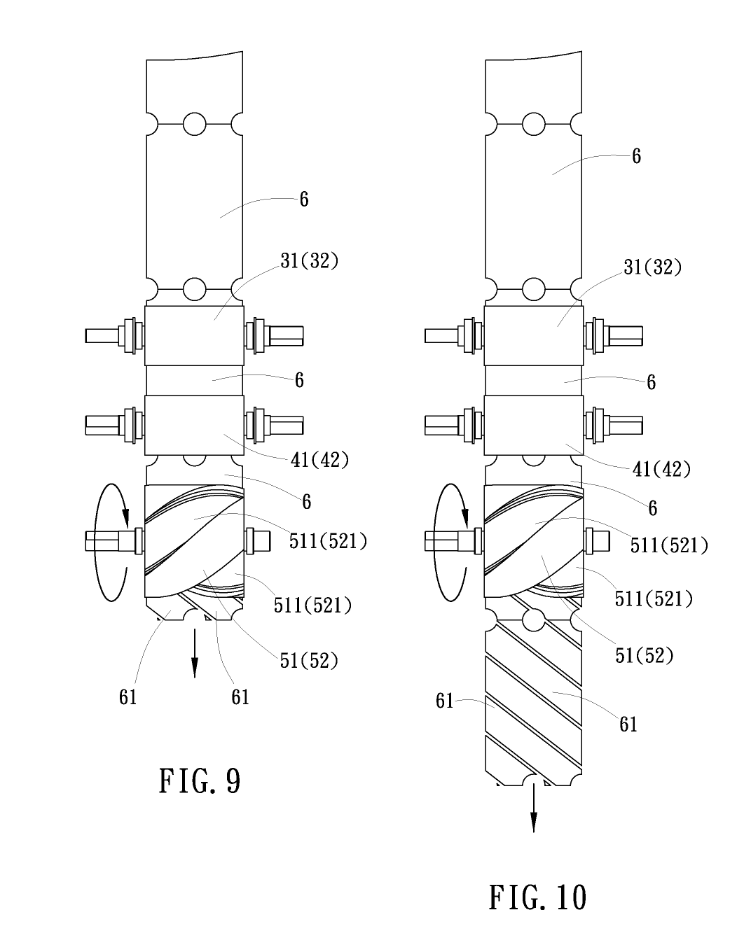

The scissor action rotary cutters 51;52 are arranged in a pair below the second set of sheet-transfer rollers 41;42. Further, the scissor action rotary cutters 51;52 each comprise a plurality of spiral cutting grooves 511,521 spaced around the periphery thereof and a plurality of spiral cutting edges 512,522 respectively abutted to respective one side of the spiral cutting grooves 511,521. When a lottery ticket 6 is delivered through the gap in between the pair of scissor action rotary cutters 51;52, the lottery ticket 6 is immediately cut into multiple pieces 61 (see FIG. 9 and FIG. 10).

After the top cover shell 11 and bottom body shell 12 of the lottery ticket destruction apparatus are closed, a series of lottery tickets 6 can be inserted into the top opening 111 for destruction. Upon insertion of a series of lottery tickets 6 into the top opening 111, the sensors 141;142 sense the presence of the inserted series of lottery tickets 6 and then give a signal to start up the motor 13, driving the pinion 131 to rotate the sets of sheet-transfer rollers 31,32;41,42 at a relatively lower speed and the set of scissor action rotary cutters 51;52 at a relatively higher speed, causing the series of lottery tickets 6 to be delivered properly through the first set of sheet-transfer rollers 31,32 (that flattens the series of lottery tickets 6) and the second set of sheet-transfer roller 41,42 (that continuously deliver the series of lottery tickets 6 forward) into the set of scissor action rotary cutters 51,52 where the spiral cutting edges 512,522 of the scissor action rotary cutters 51,52 obliquely cut off the lottery tickets 6 into small pieces 61. The set of scissor action rotary cutters 51,52 simulates the cutting action of a pair of scissors to cut lottery tickets 6 into small pieces 61, thus saving waste lottery ticket storage space and facilitating further follow-up procedure.

When compared to the prior art design, the present preferred embodiment uses two sets of sheet-transfer rollers 31,32,41,42 and one set of scissor action rotary cutter 51,52, wherein the first set of sheet-transfer rollers 31,32 and the second set of sheet-transfer rollers 41,42 deliver lottery tickets 6 into the set of scissor action rotary cutters 51,52; the spiral cutting edges 512,522 of the scissor action rotary cutters 51,52 obliquely and rapidly cut off lottery tickets 6 into small pieces 61 without stretching, minimizing the load of the transmission gear set 2. So, the invention ensures that the components of the lottery ticket destruction apparatus can run smoothly, thus extending the service life. Further, the whole structure of the lottery ticket destruction apparatus is more compact and streamlined compared to the prior art design.

After thorough experimentation and tests, the cutting grooves 511,521 and cutting edges 512,522 of the scissor action rotary cutters 51,52 are spirally configured to achieve the best scissor action performance. However, this spiral configuration is not a limitation. The cutting grooves 511,521 and cutting edges 512,522 of the scissor action rotary cutters 51,52 can be configured to extend obliquely (see FIG. 9), achieving the same scissor action to cut off lottery tickets 6 into small pieces 61.

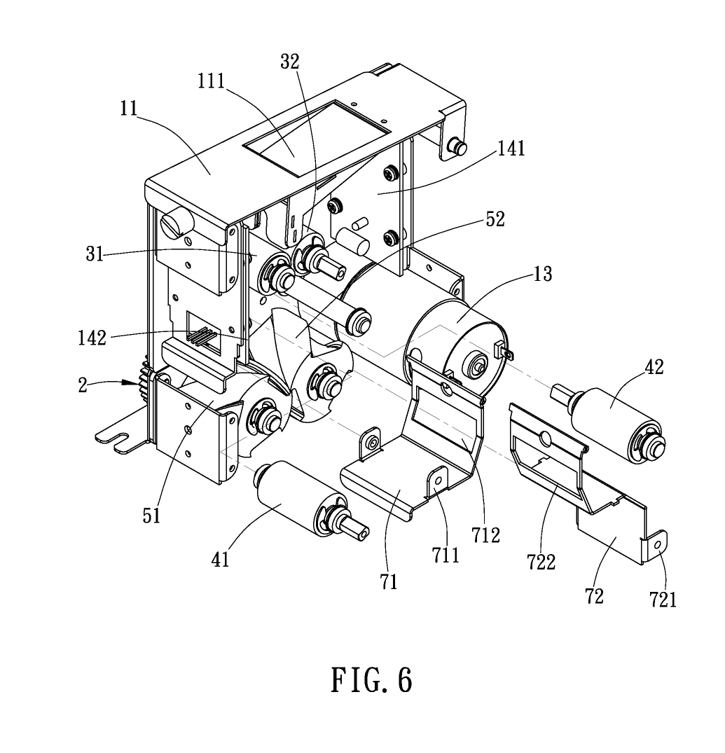

Referring to FIG. 6, shield plates 71,72 are respectively disposed around the scissor action rotary cutters 51,52 to shield the scissor action rotary cutters 51,52, preventing flying cutting dust from affecting normal functioning of the sensors 141,142 while the scissor action rotary cutters 51,52 are rotated to cut off lottery tickets 6 into small pieces 61.

Further, the shield plates 71,72 are configured to provide mounting lugs 711,721 at one or two opposite lateral sides thereof for fastening to the inside wall of the housing 1.

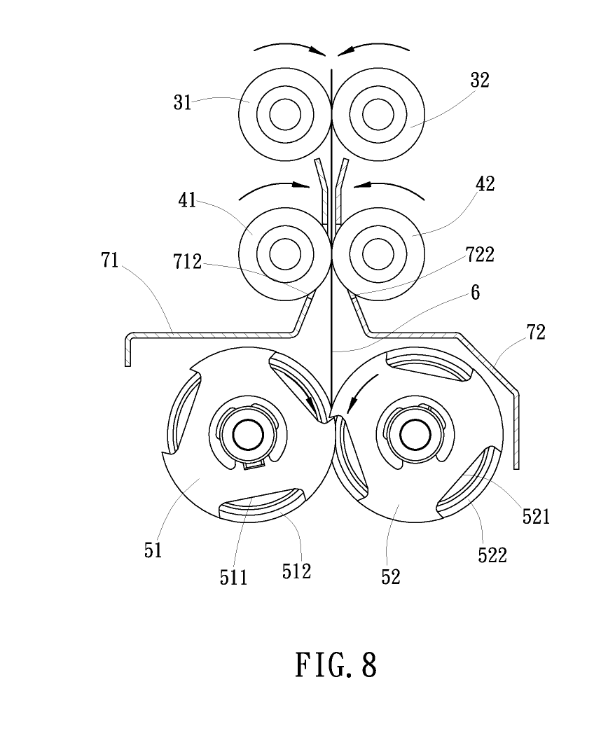

Further, the shield plates 71,72 extend upwards, each providing an opening 712,722 (see FIG. 8) for the passing of part of the second set of sheet-transfer roller 41,42. As the shield plates 71,72 extend upwards, they effectively isolate the scissor action rotary cutters 51,52 from the internal space of the housing 1, preventing flying cutting dust from entering into the internal space of the housing 1 to contaminate the sensors 141,142.

Although particular embodiments of the invention have been described in detail for purposes of illustration, various modifications and enhancements may be made without departing from the spirit and scope of the invention. For example, the housing 1 can be an enclosed structure instead of the flip-turn design; other equivalent transmission mechanism can be selectively used to substitute for the transmission gear set 2, enabling the first set of sheet-transfer rollers 31;32, the second set of sheet-transfer rollers 41,42 and the scissor action rotary cutter 51,52 to be rotated at different speeds. Accordingly, the invention is not to be limited except as by the appended claims.

When compared to the prior art design of US Publication No. 20150129691, the lottery ticket destruction apparatus of the present invention uses the scissor action rotary cutters 51,52 to cut off lottery tickets into small pieces without generating any stretching force, and also uses the shield plates 71,72 to isolate the scissor action rotary cutters 51,52 from the internal space of the housing 1, preventing the sensors 141,142 from being contaminated by cutting dust to affect sensing.

What is claimed is:

1. A lottery ticket destruction apparatus, comprising:
a housing comprising a top opening for insertion of lottery tickets;
a motor mounted in said housing and a pinion rotatable by said motor;
sensing means mounted in said housing and adapted for sensing the presence of a lottery ticket in said top opening and starting said motor to rotate;
a transmission gear set mounted outside said housing, said transmission gear set comprising a plurality of gears meshed together and drivable by said pinion;
a first set of sheet-transfer rollers and a second set of sheet-transfer rollers mounted in said housing below said top opening at different elevations and rotatable by said transmission gear set, said first set of sheet-transfer rollers being disposed adjacent to said top opening and adapted for flatten each inserted lottery ticket and delivering each flattened lottery ticket through said sensing means, said second set of sheet-transfer rollers being disposed below said first set of sheet-transfer rollers;
a set of scissor action rotary cutters arranged in pair and mounted in said housing below said second set of sheet-transfer rollers and rotatable by said transmission gear set at a relatively higher speed than said first set of sheet-transfer rollers and said second set of sheet-transfer rollers for cutting each flattened lottery ticket into small pieces through a scissor action, each said scissor action rotary cutter comprising a plurality of cutting grooves spaced around the periphery thereof,
wherein said second set of sheet-transfer rollers is adapted for delivering flattened lottery ticket from said sensing means into said set of scissor action rotary cutters, and said set of scissor action rotary cutters are rotated to cut each flattened lottery ticket into small pieces through a scissor action.

2. The lottery ticket destruction apparatus as claimed in claim 1, further comprising a shield plate surrounding each said scissor action rotary cutter to isolate the respective said scissor action rotary cutter from the internal space of said housing.

3. The lottery ticket destruction apparatus as claimed in claim 1, wherein said cutting grooves of each said scissor action rotary cutter are spirally extended around the periphery of the respective said scissor action rotary cutter.

4. The lottery ticket destruction apparatus as claimed in claim 1, wherein each said scissor action rotary cutter further comprises a spiral cutting edge abutted at one lateral side of each said spiral cutting groove thereof.

5. The lottery ticket destruction apparatus as claimed in claim 1, wherein said housing comprises a bottom body shell, and a top cover shell pivotally coupled to said bottom body shell and flip-turnable relative to said bottom body shell.

6. The lottery ticket destruction apparatus as claimed in claim 2, wherein said shield plate comprises at least one mounting lug located at at least one of two opposite lateral sides for fastening to an inside wall of said housing.

7. The lottery ticket destruction apparatus as claimed in claim 2, wherein said shield plate extends upwards and has an opening for the passing of part of said second set of sheet-transfer rollers.
